(19) United States
(12) Patent Application Publication
(10) Pub. No.: US 2026/0030608 A1
(43) Pub. Date: Jan. 29, 2026

(54) CONCURRENT REBALANCING OF CRYPTOCURRENCY ACROSS MULTIPLE CRYPTOCURRENCY NETWORKS

(71) Applicant: Circle Internet Group, Inc., New York, NY (US)

(72) Inventors: Christopher Aubin, Boston, MA (US); Terje Andre Bratlie, Boston, MA (US); Xianglin Liu, Boston, MA (US); Zhen Yong Lu, Boston, MA (US)

(21) Appl. No.: 18/786,348

(22) Filed: Jul. 26, 2024

(51) Int. Cl. G06Q 20/06; G06Q 20/36

(52) U.S. Cl. CPC G06Q 20/0652; G06Q 20/367

(57) ABSTRACT

Implementations for concurrent rebalancing can include determining a set of actual ratios for chain networks, each actual ratio representing a relative number of tokens of a cryptocurrency within a respective chain network, comparing actual ratios to respective target ratios in a set of target ratios to provide a set of differences, determining that a rebalance job is to be executed for a first chain network in the set of chain networks in response to the set of differences, and in response, defining a rebalance job for the first chain network, the rebalance job including a first transaction to be executed on the first chain network and a second transaction to be executed on a second chain network, performing a set of checks based on the rebalance job and at least one on-going rebalance job, and selectively executing the rebalance job.

### TECHNICAL FIELD

This specification relates generally to cryptocurrency in cryptocurrency networks and more particularly to maintaining ratios of distributions of tokens of a cryptocurrency across multiple cryptocurrency networks.

### BACKGROUND

The development of distributed ledger technology has enabled a multitude of digital transactions not available in the pre-Internet world. For example, distributed ledger technology enables users to hold digital assets as stores of value and mediums of exchange with immutability and traceability. In general, a digital asset can be described as a virtual store of value that leverages a distributed ledger to store, record, and validate transactions. Distributed ledgers can be referred to as blockchains or chains.

An example digital asset includes cryptocurrencies, which can be distributed as tokens. Tokens of a cryptocurrency can reside on multiple networks (i.e., multiple chains). For example, a provider of the cryptocurrency can keep a store of a first number of tokens on a first network and a store of a second number of tokens on a second network. In this manner, for example, tokens of the cryptocurrency can be made available to users of the cryptocurrency on both the first network and the second network. For example, a first amount of the cryptocurrency can be transferred on the first network and a second amount of the cryptocurrency can be transferred on the second network.

The provider of the cryptocurrency can seek to maintain target ratios of tokens of the cryptocurrency across the multiple networks. For example, of the total number of tokens of the cryptocurrency, the provider of the cryptocurrency can seek to maintain X % on a first network, Y % on a second network, and Z % on a third network (where X+Y+Z=100). However, as users purchase amounts of the cryptocurrency from the provider across the multiple networks and/or amounts of cryptocurrency are transferred between networks, the ratio of tokens can drift from the target ratios. To remediate this, a rebalance can be executed to remove tokens from one or more networks and add tokens to one or more other networks.

### SUMMARY

This specification describes systems, methods, devices, and other techniques relating to rebalancing of tokens of a cryptocurrency across multiple cryptocurrency networks. More particularly, implementations of the present disclosure are directed to concurrent rebalancing to maintain target ratios of tokens of a cryptocurrency distributed across multiple cryptocurrency networks.

In general, innovative aspects of the subject matter described in this specification can include actions of determining a first set of actual ratios for a set of chain networks, each actual ratio in the first set of actual ratios representing a relative number of tokens of a cryptocurrency within a respective chain network of the set of chain networks, comparing actual ratios in the first set of actual ratios to respective target ratios in a set of target ratios to provide a first set of differences, determining that a first rebalance job is to be executed for a first chain network in the set of chain networks in response to the first set of differences, and in response, defining a first rebalance job for the first chain network, the first rebalance job including a first transaction to be executed on the first chain network and a second transaction to be executed on a second chain network in the set of chain networks, performing at least a portion of a set of checks based on the first rebalance job and at least one on-going rebalance job in response to determining that the first rebalance job is a concurrent rebalance job, and executing the first rebalance job in response to the first rebalance job meeting the at least a portion of the set of checks. Other implementations of this aspect include corresponding systems, apparatus, and computer programs, configured to perform the actions of the methods, encoded on computer storage devices.

These and other implementations can each optionally include one or more of the following features: the at least a portion of the set of checks including one or more of whether a burn chain of the first rebalance job is a mint chain of the on-going rebalance job, whether the burn chain of the first rebalance job is a burn chain of the on-going rebalance job, whether a mint chain of the first rebalance job is a mint chain of the on-going rebalance job and, if so, whether a burn chain of the on-going rebalance job is of slow finality and the mint chain of the on-going rebalance job requires tokens of the cryptocurrency, and whether one of the mint chain of the first rebalance job is a burn chain of the on-going rebalance job and the mint chain of the on-going rebalance job is blocked by a burn transaction on a burn chain of slow finality; actions further include delaying execution of the first rebalance job until the first rebalance job meets the at least a portion of the set of checks; the first transaction is executed by a first smart contract in the first chain network and is recorded in a first blockchain maintained within the first chain network, and the second transaction is executed by a second smart contract in the second chain network and is recorded in a second blockchain maintained within the second chain network; the first transaction changes a first reserve held by a provider of the cryptocurrency within the first chain network by a number of tokens determined based on a difference between a target ratio and an actual ratio, and the second transaction changes a second reserve held by the provider of the cryptocurrency within the second chain network by the number of tokens; actions further include determining a second set of actual ratios for the set of chain networks, comparing actual ratios in the second set of actual ratios to respective target ratios in the set of target ratios to provide a second set of differences, determining that a rebalance job is to be executed for the first chain network in the set of chain networks in response to the second set of differences, and in response, defining a second rebalance job for the first chain network, the second rebalance job including a third transaction to be executed on the first chain network and a fourth transaction to be executed on the second chain network, and executing the second rebalance job in response to determining that the second rebalance job is not a concurrent rebalance job; and executing the first rebalance job includes transmitting instructions to the first chain network to execute the first transaction, and transmitting instructions to the second chain network to execute the second transaction.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual architecture in accordance with implementations of the present disclosure.

FIG. 2 is an example signal flow diagram in accordance with implementations of the present disclosure.

FIG. 3 depicts a flowchart of an example process that can be executed in accordance with implementations of the present disclosure.

Like reference numbers and designations in the various drawings indicate like elements.

### DETAILED DESCRIPTION

The technology of this patent application is directed to rebalancing of tokens of a cryptocurrency across multiple cryptocurrency networks. More particularly, implementations of the present disclosure are directed to concurrent rebalancing to maintain targets ratio of tokens of a cryptocurrency distributed across multiple cryptocurrency networks.

In some implementations, actions include determining a set of actual ratios for a set of chain networks, each actual ratio in the set of actual ratios representing a relative number of tokens of a cryptocurrency within a respective chain network of the set of chain networks, comparing actual ratios in the set of actual ratios to respective target ratios in a set of target ratios to provide a set of differences, determining that a rebalance job is to be executed for a first chain network in the set of chain networks in response to the set of differences, and in response, defining a rebalance job for the first chain network, the rebalance job including a first transaction to be executed on the first chain network and a second transaction to be executed on a second chain network in the set of chain networks, performing at least a portion of a set of checks based on the rebalance job and at least one on-going rebalance job in response to determining that the rebalance job is a concurrent rebalance job, and executing the rebalance job in response to the rebalance job meeting the at least a portion of the set of checks.

To provide context for the subject matter of the present disclosure, and as introduced above, users can hold digital assets as stores of value and mediums of exchange. In general, a digital asset can be described as a virtual store of value that leverages a distributed ledger (e.g., blockchain) to store, record and validate transactions. A distributed ledger can be described as a decentralized database that immutably stores transactions across a peer-to-peer network. Distributed ledgers can be referred to as blockchains, or chains that are maintained in a chain network (e.g., a network of peer-to-peer nodes). Example digital assets can include, without limitation, cryptocurrencies (e.g., stablecoins), non-fungible tokens (NFTs), security tokens, and the like. For purposes of non-limiting illustration, implementations of the present disclosure are described in further detail herein with reference to example cryptocurrencies. It is contemplated, however, that implementations of the present disclosure can be realized using any appropriate digital assets.

In some examples, a cryptocurrency can be described as a digital currency that uses cryptography to secure transactions that are recorded in a distributed ledger (e.g., blockchain). Cryptocurrencies are distributed as tokens (e.g., cryptographic values that represent an amount of the cryptocurrency). In some examples, a stablecoin can be described as a cryptocurrency having a value that is tied (pegged) to the value of a real-world, non-digital asset, such as a fiat currency, a commodity, or a financial instrument. For example, for each token of a stablecoin, an equivalent value of the real-world, non-digital asset is maintained in reserve. Stablecoins are absent the volatility of other cryptocurrencies and, as such, are a useful medium of exchange. An example stablecoin includes, without limitation, USDC™. In this example, USDC™ is pegged 1:1 to the US dollar (USD). Consequently, a reserve of USD can be maintained and, for each USD in the reserve, a token of USDC™ is provided.

In general, tokens of a cryptocurrency can be generated using a minting process. Minting can generally be described as generating tokens of a cryptocurrency through execution of cryptographic transactions within a network and recording the transactions in a blockchain maintained within the network. In some examples, minting is executed through a minting function of a smart contract (minter) that is executed within the network. On the other hand, tokens of a cryptocurrency can be permanently removed from circulation within a network using a burning process. Burning can generally be described as permanently removing tokens of a cryptocurrency from circulation through execution of cryptographic transactions within a network and recording the transactions in a blockchain maintained within the network. In some examples, burning is executed through a burning function of a smart contract (burner) that is executed within the network. Smart contracts can be described as programs that are executed on-chain and are each provided as a collection of code (functions) and data (state) that resides at a specific address on the chain.

Tokens of a cryptocurrency can reside on multiple networks (i.e., multiple chains). For example, a provider of the cryptocurrency can keep a first reserve (RES₁) of a first number of tokens on a first network (N₁), a second reserve (RES₂) of a second number of tokens on a second network (N₂), and an n^{th} reserve (RESₙ) of an n^{th} number of tokens on an n^{th} network (Nₙ). In this manner, for example, tokens of the cryptocurrency can be made available to users of the cryptocurrency on each of the networks. For example, a user can purchase a first amount of the cryptocurrency from the first reserve (RES₁) on the first network (N₁). This results in a transfer of the first amount from the first reserve (RES₁) to an account of the user, which diminishes the number of tokens held in the first reserve (RES₁) on the first network (N₁).

The provider of the cryptocurrency can seek to maintain target ratios of tokens of the cryptocurrency held in reserves across the multiple networks. For example, relative to a total number of tokens of the cryptocurrency that are held by the provider (A_{TOT_P}), the provider of the cryptocurrency can seek to maintain a first target ratio (R_{T1}) on the first network (N₁), a second target ratio (R_{T2}) on the second network (N₂), and an n^{th} target ratio (R_{Tn}) on the n^{th} network (Nₙ) (where R_{T1}+R_{T2}+ . . . +R_{Tn}=1). However, as numbers of tokens of the cryptocurrency in the respective reserves changes one or more of the multiple networks, the ratios of tokens drifts from the target ratios. For example, and continuing with the example above, an amount of cryptocurrency can be transferred from the first network (N₁) (e.g., a user purchases the amount of cryptocurrency), which diminishes the number of tokens available in the first reserve (RES₁). This results in a first actual ratio (R_{A1}) that is less than the first target ratio (R_{T1}). This also results in actual ratios in each of the other networks to increase from their respective target ratios. As another example, and continuing with the example above, an amount of cryptocurrency can be minted within the first network (N₁) (e.g., the provider receives USD and mints tokens of cryptocurrency for the first reserve (RES₁) responsive to the USD), which increases the number of tokens available in the first reserve (RES₁). This results in a first actual ratio (R_{A1}) that is greater than the first target ratio (R_{T1}). This also results in actual ratios in each of the other networks to decrease from their respective target ratios.

To remediate this drift, a rebalance can be executed to remove tokens from one or more networks and add tokens to one or more other networks. Rebalancing can include execution of a rebalance job that includes minting a number of tokens of the cryptocurrency on one or more networks and burning the number of tokens from one or more other networks. Example rebalancing is disclosed in U.S. application Ser. No. 17/466,900, filed on Sep. 3, 2021, and entitled Multi-Blockchain Token Rebalancer, the disclosure of which is expressly incorporated herein by reference in the entirety for all purposes. Traditional rebalancing techniques, however, have one or more disadvantages. For example, during rebalancing, only one rebalance job can be executed at a time. This can impede execution of further rebalancing tasks, if the ongoing rebalance job becomes stalled or fails (e.g., due to a stuck burn transaction). Further, this can impede execution of transactions on one or more networks. For example, if a rebalance is stalled on a first network and rebalance is needed on a second network to be able to execute transactions related to the cryptocurrency, the transactions cannot be executed on the second network until the rebalance on the first network is completed, then the rebalance on the second network is completed.

In view of the foregoing, implementations of the present disclosure are directed to concurrent rebalancing to maintain target ratios of tokens of a cryptocurrency distributed across multiple cryptocurrency networks. As described in further detail herein, implementations of the present disclosure enable multiple rebalancing jobs to be executed in parallel across multiple chain networks. For example, multiple rebalancing jobs can be executed concurrently, in which at least a portion of one rebalancing job overlaps in time with at least a portion of another rebalancing job.

Implementations of the present disclosure are described in further detail herein with reference to example peer-to-peer networks (also referred to herein as chain networks), each maintaining a respective chain. Some of the example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, Base, and Tron, among several others, each of which is EVM-compatible.

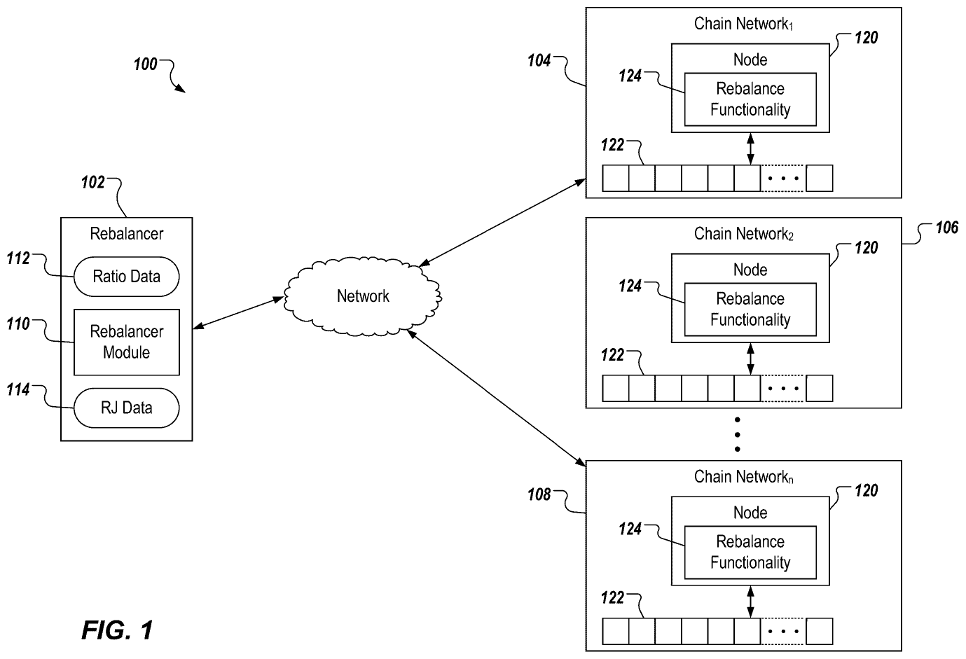

FIG. 1 depicts a conceptual architecture 100 in accordance with implementations of the present disclosure. The conceptual architecture 100 includes a rebalancer 102 and multiple chain networks 104, 106, 108. Although three chain networks are depicted in the example of FIG. 1, it is contemplated that any appropriate number of chain networks can be provided. In some examples, each chain network 104, 106, 108 represents a cryptocurrency network that enables execution of minting, burning, and transaction on digital assets. An example digital asset includes cryptocurrency, such as a stablecoin.

In accordance with implementations of the present disclosure, a provider of the cryptocurrency maintains a reserve of the cryptocurrency within each of the chain networks 104, 106, 108. For example, the provider can provide a total number of tokens of cryptocurrency (A_{TOT}) that can be collectively held by entities (e.g., users, institutions, enterprises) and the provider. For example, a sum of a number of tokens of cryptocurrency held by the provider (A_{TOT_P}) and a number of tokens of cryptocurrency held by entities (A_{TOT_E}) can equal total number of tokens of cryptocurrency (A_{TOT}) (e.g., A_{TOT}=A_{TOT_P}+A_{TOT_E}). In some implementations, the provider distributes the number of tokens of cryptocurrency (A_{TOT_P}) across reserves held by the provider in the chain networks 104, 106, 108. For example, the provider can hold a first reserve (RES₁) in the chain network 104, a second reserve (RES₂) in the chain network 106, and an n^{th} reserve (RESₙ) in the chain network 108, the reserves having respective numbers of tokens of cryptocurrency (A₁, A₂, . . . , Aₙ) therein. In some examples, each reserve can be provided as a smart contract account (SCA) owned and operated by the provider on the respective chain networks 104, 106, 108.

In accordance with implementations of the present disclosure, the provider can seek to maintain a first target ratio (R_{T1}) on the chain network 104, a second target ratio (R_{T2}) on the chain network 106, and an n^{th} target ratio (R_{Tn}) on the chain network 108. The following example relationship can be provided:

$${R}_{T 1} + {R}_{T 2} + … + {R}_{Tn} = 1$$

In some examples, the target ratios can be determined using the following example relationships:

$${R}_{T 1} = {A}_{1} / {A}_{TOT \_ P}$$

$${R}_{T 2} = {A}_{2} / {A}_{TOT \_ P}$$

$${R}_{Tn} = {A}_{n} / {A}_{TOT \_ P}$$

At any given time (t), a first actual ratio (R_{A1}) can be provided on the chain network 104, a second actual ratio (R_{A2}) can be provided on the chain network 106, and an n^{th} actual ratio (R_{An}) can be provided on the chain network 108. Ideally, the actual ratios R_{A1}, R_{A2}, R_{An} are equal to or within a threshold difference of the respective target ratios R_{T1}, R_{T2}, R_{Tn}. However, and as introduced above, actual ratios R_{A1}, R_{A2}, R_{An} can drift over time, such that one or more exceeds the threshold difference. For example, a difference (Δ) between an actual ratio and a target ratio can be determined (e.g., |R_{A}-R_{T}|; |R_{A}-R_{T}|/R_{T}) and can be compared to a threshold difference (ATHR). If the difference exceeds the threshold difference, the actual ratio is deemed to have drifted from the target ratio to an unacceptable degree, and rebalancing is to be performed.

In some examples, the threshold difference (ATHR) can be described as a float variable value. By providing a float variable, the total number of tokens of the cryptocurrency in a given chain network may fluctuate about the respective target ratio by the float variable value before a rebalancing job is initiated. For example, the float variable value may be represented as a percentage (e.g., 0.03 or 3%), in a number of tokens (e.g., 300,000 tokens), or as combination thereof.

To correct for drift, a rebalancer selectively executes rebalancing jobs (RJs) to rebalance numbers of tokens of the cryptocurrency across multiples of the chain networks. Each rebalance job includes a mint job and one or more burn jobs. In some examples, the mint job is executed to mint a number of tokens of the cryptocurrency on a chain network, and the one or more burn jobs are executed to burn respective burn an equal number of tokens of the cryptocurrency on one or more chain networks, collectively. Here, a chain network that a mint job is executed on can be referred to as a mint chain, and a chain network that a burn job is executed on can be referred to as a burn chain.

With continued reference to FIG. 1, the rebalancer 102 includes a rebalance module 110, ratio data 112, and rebalance job (RJ) data 114. Each of the chain networks 104, 106, 108 includes multiple nodes including a node 120 and maintains a chain 122 (blockchain). In the example of FIG. 1, each node 120 executes rebalance functionality 124, as described in further detail herein. In some examples, the rebalance functionality 124 can be provided by a smart contract, such as a rebalance contract, that is executed within the node 120. In some examples, the rebalance functionality 124 can be provided as a set of primitive functions that are native to a respective chain network.

The rebalance functionality 124 can include token implementation functions (TIFs), which can include, but is not limited to, a current balance function, a mint function, and a burn function. In some examples, the current balance function tracks the total number of tokens of the cryptocurrency on the respective chain network, the mint function generates new tokens for use in transactions within the respective chain network, and the burn function permanently removes tokens from circulation with the respective chain network. In some examples, the current balance function includes a current number of tokens of the cryptocurrency within the chain network. In some examples, the current balance function includes a current number of tokens of the cryptocurrency within a reserve on the chain network (e.g., RES₁, RES₂, . . . , RESₙ).

In some implementations, the rebalancer 102 stores token-related data representative of tokens of a cryptocurrency distributed across the chain networks 104, 106, 108. The following table depicts examples of token-related data that can be maintained by the rebalancer 102:

TABLE 1
Example Token-Related Data at Time t

| Chain Network | Amount (A) | Entities | Providers |
|---|---|---|---|
| CN₁ | A₁ | A_{E, 1} | A_{P, 1} |
| CN₂ | A₂ | A_{E, 2} | A_{P, 2} |
| . . . | . . . | . . . | . . . |
| CNₙ | Aₙ | A_{E, n} | A_{P, n} |

From the example table above, the following example relationships can be provided:

$${A}_{TOT \_ P} = {A}_{P , 1} + {A}_{P , 2} + … + {A}_{P , n}$$

$${A}_{TOT \_ E} = {A}_{E , 1} + {A}_{E , 2} + … + {A}_{E , n}$$

$${A}_{TOT} = {A}_{TOT \_ P} + {A}_{TOT \_ E} = {A}_{1} + {A}_{2} + … + {A}_{n}$$

Although not depicted in the example of Table 1, the rebalancer 102 stores target ratio data for each of the chain networks 104, 106, 108 (e.g., target ratios R_{T1}, R_{T2}, . . . , R_{Tn}). In some examples, the example of Table 1 represents a specific time (t), as values vary over time (e.g., transactions are executed within one or more chain networks after t).

In some implementations, the rebalancer 102 queries the chain networks 104, 106, 108 to obtain numbers of tokens of the cryptocurrency within the respective chain networks 104, 106, 108. For example, at a time t, the rebalancer 102 transmits a query to each chain network 104, 106, 108, each chain network 104, 106, 108 processing the query (e.g., by a smart contract) and providing a respective response. In some examples, responses can include:

$${[ {A}_{1} , {RES}_{1} ]}_{t}$$

$${[ {A}_{2} , {RES}_{2} ]}_{t}$$

$$…$$

$${[ {A}_{n} , {RES}_{n} ]}_{n}$$

In some examples, the rebalancer 102 can process the responses to determine token-related data, such as that represented in the example of Table 1. For example:

$${[ {RES}_{1} = {A}_{P , 1} ; {RES}_{2} = {A}_{P 2} ; … ; {RES}_{n} = {A}_{P , n} ]}_{t}$$

$${[ {A}_{E , 1} = {A}_{1} - {A}_{P , 1} ; {A}_{E , 2} = {A}_{2} - {A}_{P , 2} ; … ; {A}_{E , n} = {A}_{n} - {A}_{P , n} ]}_{t}$$

$${[ {A}_{TOT \_ P} = {A}_{P , 1} + {A}_{P , 2} + … + {A}_{P , n} ]}_{t}$$

$${[ {A}_{TOT \_ E} = {A}_{E , 1} + {A}_{E , 2} + … + {A}_{E , n} ]}_{t}$$

$${[ {A}_{TOT} = {A}_{TOT \_ P} + {A}_{TOT \_ E} ]}_{t}$$

Further, the rebalancer 102 determines actual ratios at time t for each of the chain networks 104, 106, 108. The following table depicts example calculations for determining the actual ratios at time t:

TABLE 2
Example Calculations for Actual Ratios

| Actual Ratios | Example 1 | Example 2 |
|---|---|---|
| R_{A1} | A₁/A_{TOT} | A_{P, 1}/A_{TOT} |
| R_{A2} | A₂/A_{TOT} | A_{P, 2}/A_{TOT} |
| . . . | . . . | . . . |
| R_{An} | A₃/A_{TOT} | A_{P, n}/A_{TOT} |

In some implementations, the rebalancer 102 compares the actual ratios to target ratios to determine whether any of the actual ratios have drifted by an unacceptable amount since a previous time t−1. For example, and as introduced above, the rebalancer 102 can store the target ratio for each chain network 104, 106, 108 in the ratio data 112 and can determine, for each chain network 104, 106, 108, a difference. For example:

$${Δ}_{1} = \vert {R}_{A 1} - {R}_{T 1} \vert$$

$${Δ}_{2} = \vert {R}_{A 2} - {R}_{T 2} \vert$$

$$…$$

$${Δ}_{n} = \vert {R}_{An} - {R}_{Tn} \vert$$

The rebalancer compares each of the differences to a threshold difference (Δ_{THR}), introduced above. In some examples, if a difference does not exceed the threshold difference (Δ_{THR}), the actual ratio of the respective chain network is determined to not have drifted from the target ratio of the respective chain network by an unacceptable amount. In some examples, if a difference exceeds the threshold difference (Δ_{THR}), the actual ratio of the respective chain network is determined to have drifted from the target ratio of the respective chain network by an unacceptable amount.

In accordance with implementations of the present disclosure, if the actual ratio of the respective chain network is determined to have drifted from the target ratio of the respective chain network by an unacceptable amount, a rebalance job is initiated for the chain network. In some examples, a number of tokens of the cryptocurrency required to rebalance the chain network is determined by the rebalancer 102. By way of non-limiting example, it can be determined that the actual ratio R_{A1} of the chain network 104 has drifted from the target ratio R_{T1} of the chain network 104 by an unacceptable amount. In view of this, a rebalance job is initiated for the chain network 104 and the number of tokens of the cryptocurrency required to rebalance the chain network 104 is determined as:

$$Δ {A}_{P , 1} = {A}_{P , 1} - [ {R}_{T 1} \times {A}_{TOT} ]$$

In some examples, if ΔA_{P,1} is positive, ΔA_{P,1} indicates a number of tokens of the cryptocurrency that are to be burned in the chain network 104, and, if ΔA_{P,1} is negative, ΔA_{P,1} indicates a number of tokens of the cryptocurrency that are to be minted in the chain network 104.

For the rebalance job, it can be determined to mint or burn tokens of the cryptocurrency on one or more other chain networks. Continuing with the non-limiting example above, it can be determined to mint or burn tokens of the cryptocurrency on one or more of the chain network 106 and the chain network 108. For example, if ΔA_{P,1} is positive, it can be determined to mint an equivalent number of tokens, collectively, on one or more of the chain network 106 and the chain network 108. As another example, if ΔA_{P,1} is negative, it can be determined to burn an equivalent number of tokens, collectively, on one or more of the chain network 106 and the chain network 108. By way of non-limiting example, it can be determined that an equivalent number of tokens is to be minted/burned on the chain network 106. For example, if ΔA_{P,1} is positive, it can be determined to mint an equivalent number of tokens on the chain network 106, and, if ΔA_{P,1} is negative, it can be determined to burn an equivalent number of tokens on the chain network 106. Accordingly, example rebalance jobs for the chain network 104 can be provided as:

$$R {J}_{1} = [ burn Δ {A}_{P , 1} on C {N}_{1} , mint Δ {A}_{P , 1} on C {N}_{2} ] ; ( Δ {A}_{P , 1} > 0 )$$

$$R {J}_{1} = [ mint Δ {A}_{P , 1} on C {N}_{1} , burn Δ {A}_{P , 1} on C {N}_{2} ] ; ( Δ {A}_{P , 1} < 0 )$$

In some examples, the rebalancer 102 determines candidate chain networks as mint/burn chains based on a distance that respective chain networks are from their target ratios. For example, and with reference to the examples above, to burn ΔA_{P,1}, on CN₁ a set of chain networks including CN₂ can be determined as chain networks that are each below their target ratios. In this example, it can be determined to mint ΔA_{P,1} on CN₂ in response to determining that CN₂ is the furthest from its target ratio than all other chain networks in the set of chain networks. As another example, and with continued reference to the examples above, to mint ΔA_{P,1} on CN₁, a set of chain networks including CN₂ can be determined as chain networks that are each above their target ratios. In this example, it can be determined to burn ΔA_{P,1} on CN₂ in response to determining that CN₂ is the furthest from its target ratio than all other chain networks in the set of chain networks.

In some examples, in the case where a mint transaction is to be executed to rebalance a chain network, the burn chain (or chains) that are selected cannot be a chain with slow finality. Here, slow finality can indicate that the chain network would take a time to finalize a burn transaction that exceeds a threshold time. In some examples, each chain network is associated with one or more parameters, one parameter indicating a speed of finality of the chain network. Consequently, the rebalancer 102 can determine whether a candidate chain network for a burn transaction is indicated as having slow finality and, if so, not include the chain network as a burn chain in the rebalance job. For example, and with continued reference to the non-limiting example above, in which RJ₁ includes minting ΔA_{P,1} on CN₁, it can be determined that CN₂ is not of slow finality. Consequently, RJ₁ includes burning ΔA_{P,1} on CN₂. If, however, CN₂ was of slow finality, CN₂ would not have been included in RJ₁ and another chain network would need to be identified for the burn transaction.

In some implementations, the rebalancer 102 tracks rebalance jobs and stores data representative of rebalance jobs as RJ data 114. In some examples, for each rebalance job, the following parameters are stored: mint chain(s), burn chain(s), start time, end time, and status. In some examples, a mint chain is a chain network that is executing a mint transaction for the rebalance job and is identified using a universally unique identifier (UUID), and a burn chain is a chain network that is executing a burn transaction for the rebalance job and is identified using a UUID. In some examples, the start time indicates a time, at which the rebalance job was initiated, and the end time indicates a time, at which the rebalance job is completed. In some examples, the status indicates a status of the rebalance job (e.g., PENDING, IN-PROGRESS, COMPLETED).

In accordance with implementations of the present disclosure, the rebalancer 102 determines whether there is any ongoing rebalance job, such that the new rebalance job would be concurrently executed. For example, the rebalancer 102 can reference the RJ data 114 to identify any rebalance jobs that were initiated prior to the time t and have a status indicating that the rebalance job(s) is/are not complete. If no such rebalance job exists, it is determined to execute the rebalance job. If such a rebalance job exists, the rebalancer 102 determines that the rebalance job would be a concurrent rebalance job (e.g., overlapping in time with on-going rebalance job(s)), and the rebalancer 102 performs multiple checks to determine when the rebalance job is to be executed.

In further detail, the rebalancer 102 retrieves data representative of each of the on-going rebalance jobs. Here, on-going indicates a rebalance job that was initiated at a time before the time t (e.g., a time <t) and does not have a status indicating completion. The rebalancer 102 determines whether any burn chain of the rebalance job (RJₜ) is included as a mint chain in any on-going rebalance job (RJ_{<t}). If a burn chain of the rebalance job (RJₜ) is included as a mint chain in any on-going rebalance job (RJ_{<t}), the rebalance job (RJₜ) is delayed and a retry is performed. If a burn chain of the rebalance job (RJₜ) is not included as a mint chain in any on-going rebalance job (RJ_{<t}), the rebalancer 102 determines whether any burn chain of the rebalance job (RJₜ) is included as a burn chain in any on-going rebalance job (RJ_{<t}). If a burn chain of the rebalance job (RJₜ) is included as a burn chain in any on-going rebalance job (RJ_{<t}), the rebalance job (RJₜ) is delayed and a retry is performed.

If a burn chain of the rebalance job (RJₜ) is not included as a burn chain in any on-going rebalance job (RJ_{<t}), the rebalancer 102 determines whether any mint chain of the rebalance job (RJₜ) is included as a mint chain in any on-going rebalance job (RJ_{<t}). If a mint chain of the rebalance job (RJₜ) is not included as a mint chain in any on-going rebalance job (RJ_{<t}), it is determined whether any mint chain of the rebalance job (RJₜ) is a burn chain in any on-going rebalance job (RJ_{<t}). If a mint chain of the rebalance job (RJₜ) is included as a mint chain in any on-going rebalance job (RJ_{<t}), it is determined whether the burn chain of the on-going rebalance job (RJ_{<t}) is of slow finality and funds are needed for the mint chain of the on-going rebalance job (RJ_{<t}) (e.g., more tokens need to be burned on burn chain to mint tokens on mint chain). If the burn chain of the on-going rebalance job (RJ_{<t}) is not of slow finality or funds are not needed for the mint chain of the on-going rebalance job (RJ_{<t}), the rebalance job (RJₜ) is delayed and a retry is performed. If the burn chain of the on-going rebalance job (RJ_{<t}) is of slow finality and funds are needed for the mint chain of the on-going rebalance job (RJ_{<t}), it is determined whether any mint chain of the rebalance job (RJₜ) is a burn chain in any on-going rebalance job (RJ_{<t}).

If each mint chain of the rebalance job (RJₜ) is a burn chain in any on-going rebalance job (RJ_{<t}), the rebalance job (RJₜ) is executed. If any mint chain of the rebalance job (RJₜ) is not a burn chain in any on-going rebalance job (RJ_{<t}), it is determined whether any mint chain of the on-going rebalance job (RJ_{<t}) is blocked. This can occur, for example, by a burn transaction on a chain with slow finality, such that, with respect to the on-going rebalance job (RJ_{<t}), the mint transaction cannot occur until the burn transaction is complete. If no mint chain of the on-going rebalance job (RJ_{<t}) is blocked, the rebalance job (RJₜ) is delayed and a retry is performed. If each mint chain of the on-going rebalance job (RJ_{<t}) is blocked, the rebalance job (RJₜ) is executed.

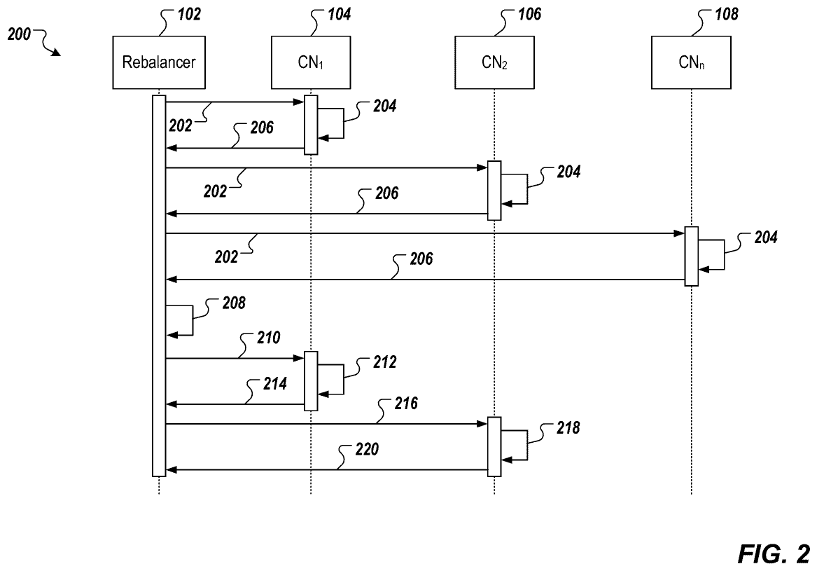

FIG. 2 is an example signal flow diagram 200 in accordance with implementations of the present disclosure. The example signal flow diagram 200 of FIG. 2 represents interactions between the rebalancer 102 and the chain networks 104, 106, 108 of FIG. 1.

In the example of FIG. 2, the rebalancer 102 transmits (202) requests (e.g., queries) to each of the chain networks 104, 106, 108. For example, the rebalancer 102 can transmit the requests in response to a rebalance check event (e.g., periodic rebalance check, triggered rebalance check). Each of the chain networks 104, 106, 108 processes (204) the request and returns (206) a response to the request. In some examples, the requests are sent and the responses are received in parallel with one another. The rebalancer 102 processes (208) the responses to determine whether any of the chain networks 104, 106, 108 needs rebalancing, as described in detail herein.

In the example of FIG. 2, it can be determined that the chain network 104 is to be rebalanced and a rebalancing job is defined that includes the chain network 106. For example, example rebalance jobs for the chain network 104 can be provided as:

$$R {J}_{1} = [ burn Δ {A}_{P , 1} on C {N}_{1} , mint Δ {A}_{P , 1} on C {N}_{2} ] ; ( Δ {A}_{P , 1} > 0 )$$

$$R {J}_{1} = [ mint Δ {A}_{P , 1} on C {N}_{1} , burn Δ {A}_{P , 1} on C {N}_{2} ] ; ( Δ {A}_{P , 1} < 0 )$$

The rebalancer 102 transmits (210) instructions to the chain network 104, which processes (212) the instructions to execute a transaction (e.g., burn ΔA_{P,1}, mint ΔA_{P,1}) (e.g., a smart contract on the chain network 104 executes the transaction). In some examples, after the transaction is executed, the chain network 104 transmits (214) a response to the rebalancer 102. The rebalancer 102 transmits (216) instructions to the chain network 106, which processes (218) the instructions to execute a transaction (e.g., mint ΔA_{P,1}, burn ΔA_{P,1}) (e.g., a smart contract on the chain network 106 executes the transaction). In some examples, after the transaction is executed, the chain network 106 transmits (220) a response to the rebalancer 102. In some examples, after both the chain network 104 and the chain network 106 execute their respective transactions and responses are received by the rebalancer 102, the rebalancer 102 can set the status of the rebalancing job (RJ₁) to COMPLETE (assuming the transactions were successfully executed).

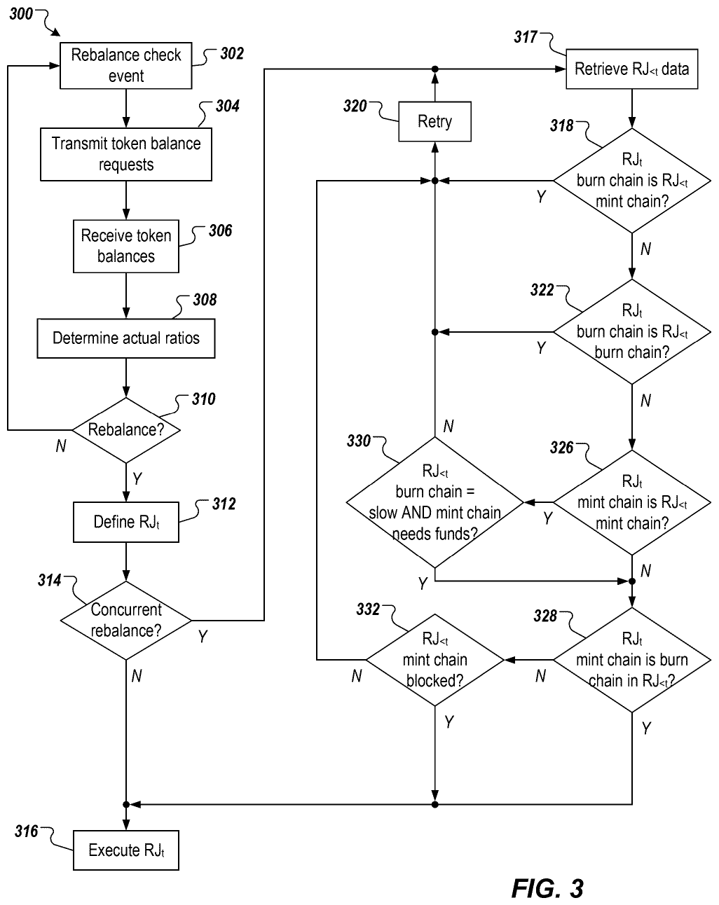

FIG. 3 depicts a flowchart of an example process 300 that can be executed in accordance with implementations of the present disclosure. For convenience, the process 300 will be described as being performed by a system of one or more computers located in one or more locations. For example, components of the architecture 100 of FIG. 1, appropriately programmed, can perform example process 300. Although the flowchart depicts the various stages of the process 300 occurring in a particular order, certain stages may in some implementations be performed in parallel or in a different order than what is depicted in the example process 300 of FIG. 3.

A rebalance check event occurs (302). For example, and with reference to FIG. 1, the rebalancer 102 can periodically (e.g., daily, weekly, monthly) check as to whether any of the chain networks 104, 106, 108 is to be rebalanced. As another example, a rebalance check event can be triggered by one or more actions (e.g., a transaction executed on a chain network that involves a number of tokens of a cryptocurrency that exceeds a threshold number of tokens). Token balance requests are transmitted (304) and token balances are received (306). For example, and as described herein, the rebalancer 102 queries the chain networks 104, 106, 108 to obtain numbers of tokens of the cryptocurrency within the respective chain networks 104, 106, 108. For example, at a time t, the rebalancer 102 transmits a query to each chain network 104, 106, 108, each chain network 104, 106, 108 processing the query (e.g., by a smart contract) and providing a respective response.

Actual ratios are determined (308). For example, and as described herein, the rebalancer 102 determines actual ratios at time t for each of the chain networks 104, 106, 108. It is determined whether one or more rebalance jobs are to be executed (310). For example, and as described herein, the rebalancer 102 compares the actual ratios to target ratios to determine whether any of the actual ratios have drifted by an unacceptable amount. The rebalancer compares each of the differences to a threshold difference (Δ_{THR}). If a difference does not exceed the threshold difference (Δ_{THR}), the actual ratio of the respective chain network is determined to not have drifted from the target ratio of the respective chain network by an unacceptable amount. Hence, a rebalance job is not needed for the respective chain network and the example process 300 loops back (assuming rebalance jobs are not needed for any other chain network). If a difference exceeds the threshold difference (Δ_{THR}), the actual ratio of the respective chain network is determined to have drifted from the target ratio of the respective chain network by an unacceptable amount, and a rebalance job is initiated for the respective chain network.

If a rebalance job is initiated, the rebalance job (RJₜ) is defined (312). For example, and as described in detail herein, the rebalancer 102 determines a number of tokens of the cryptocurrency to mint/burn on the chain network that needs rebalancing, identifies one or more other chain networks to burn/mint an equivalent (or approximately equivalent) number of tokens on. It is determined whether the rebalance job (RJₜ) is a concurrent rebalance (314). For example, and as described in detail herein, the rebalancer 102 determines whether there is any ongoing rebalance job, such that the new rebalance job would be concurrently executed. For example, the rebalancer 102 can reference the RJ data 114 to identify any rebalance jobs that were initiated prior to the time t and have a status indicating that the rebalance job(s) is/are not complete (e.g., status of PENDING or IN-PROGRESS). If no such rebalance job exists (i.e., the rebalance job (RJₜ) would not be a concurrent rebalance, it is determined to execute the rebalance job (316). Executing the rebalance job (RJₜ) can include transmitting respective instructions to the chain networks included in the rebalance job (RJₜ) to mint/burn respective numbers of tokens on the respective chain networks. For example, and in response to the instructions, a smart contract executed in a chain network performs minting/burning of a respective number of tokens of the cryptocurrency. In some examples, after completing the minting/burning, the smart contract provides a message to the rebalancer 102 indicating completion.

If the rebalance job (RJₜ) would be a concurrent rebalance job, data representative of each on-going rebalance job (RJ_{<t}) is retrieved (317). For example, the rebalancer 102 retrieves data representative of each of the on-going rebalance jobs (RJ_{<t}) from the RJ data 114. It is determined whether any burn chain of the rebalance job (RJₜ) is included as a mint chain in any on-going rebalance job (RJ_{<t}) (318). For example, the rebalancer 102 determines whether any burn chain of the rebalance job (RJₜ) is included as a mint chain in any on-going rebalance job (RJ_{<t}). If a burn chain of the rebalance job (RJₜ) is included as a mint chain in any on-going rebalance job (RJ_{<t}), the rebalance job (RJₜ) is delayed and a retry is performed (320). In some examples, the retry is performed after a delay period expires (e.g., seconds, minutes, hours). If a burn chain of the rebalance job (RJₜ) is not included as a mint chain in any on-going rebalance job (RJ_{<t}), it is determined whether any burn chain of the rebalance job (RJₜ) is included as a burn chain in any on-going rebalance job (RJ_{<t}) (322). For example, the rebalancer 102 determines whether any burn chain of the rebalance job (RJₜ) is included as a burn chain in any on-going rebalance job (RJ_{<t}). If a burn chain of the rebalance job (RJₜ) is included as a burn chain in any on-going rebalance job (RJ_{<t}), the rebalance job (RJₜ) is delayed and a retry is performed (320).

If a burn chain of the rebalance job (RJₜ) is not included as a burn chain in any on-going rebalance job (RJ_{<t}), it is determined whether any mint chain of the rebalance job (RJₜ) is included as a mint chain in any on-going rebalance job (RJ_{<t}) (326). For example, the rebalancer 102 determines whether any mint chain of the rebalance job (RJₜ) is included as a mint chain in any on-going rebalance job (RJ_{<t}). If a mint chain of the rebalance job (RJₜ) is not included as a mint chain in any on-going rebalance job (RJ_{<t}), it is determined whether any mint chain of the rebalance job (RJₜ) is a burn chain in any on-going rebalance job (RJ_{<t}) (328). If a mint chain of the rebalance job (RJₜ) is included as a mint chain in any on-going rebalance job (RJ_{<t}), it is determined whether the burn chain of the on-going rebalance job (RJ_{<t}) is of slow finality and funds are needed for the mint chain of the on-going rebalance job (RJ_{<t}) (330). If the burn chain of the on-going rebalance job (RJ_{<t}) is not of slow finality or funds are not needed for the mint chain of the on-going rebalance job (RJ_{<t}), the rebalance job (RJₜ) is delayed and a retry is performed (320). If the burn chain of the on-going rebalance job (RJ_{<t}) is of slow finality and funds are needed for the mint chain of the on-going rebalance job (RJ_{<t}), it is determined whether any mint chain of the rebalance job (RJₜ) is a burn chain in any on-going rebalance job (RJ_{<t}) (328).

If each mint chain of the rebalance job (RJₜ) is a burn chain in any on-going rebalance job (RJ_{<t}), the rebalance job (RJₜ) is executed (316). If any mint chain of the rebalance job (RJₜ) is not a burn chain in any on-going rebalance job (RJ_{<t}), it is determined whether any mint chain of the on-going rebalance job (RJ_{<t}) is blocked (332). This can occur, for example, by a burn transaction on a chain with slow finality, such that, with respect to the on-going rebalance job (RJ_{<t}), the mint transaction cannot occur until the burn transaction is complete. If no mint chain of the on-going rebalance job (RJ_{<t}) is blocked, the rebalance job (RJₜ) is delayed and a retry is performed (320). If each mint chain of the on-going rebalance job (RJ_{<t}) is blocked, the rebalance job (RJₜ) is executed (316).

The term “configured” can be used in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. Elements of a computer can include a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for concurrent rebalancing of tokens of a cryptocurrency across multiple cryptocurrency networks, comprising:
determining a first set of actual ratios for a set of chain networks, each actual ratio in the first set of actual ratios representing a relative number of tokens of a cryptocurrency within a respective chain network of the set of chain networks;
comparing actual ratios in the first set of actual ratios to respective target ratios in a set of target ratios to provide a first set of differences;
determining that a first rebalance job is to be executed for a first chain network in the set of chain networks in response to the first set of differences, and in response, defining a first rebalance job for the first chain network, the first rebalance job comprising a first transaction to be executed on the first chain network and a second transaction to be executed on a second chain network in the set of chain networks;
performing at least a portion of a set of checks based on the first rebalance job and at least one on-going rebalance job in response to determining that the first rebalance job is a concurrent rebalance job; and
executing the first rebalance job in response to the first rebalance job meeting the at least a portion of the set of checks.

2. The computer-implemented method of claim 1, wherein the at least a portion of the set of checks comprises one or more of:
whether a burn chain of the first rebalance job is a mint chain of the on-going rebalance job;
whether the burn chain of the first rebalance job is a burn chain of the on-going rebalance job;
whether a mint chain of the first rebalance job is a mint chain of the on-going rebalance job and, if so, whether a burn chain of the on-going rebalance job is of slow finality and the mint chain of the on-going rebalance job requires tokens of the cryptocurrency; and
whether one of the mint chain of the first rebalance job is a burn chain of the on-going rebalance job and the mint chain of the on-going rebalance job is blocked by a burn transaction on a burn chain of slow finality.

3. The computer-implemented method of claim 1, further comprising delaying execution of the first rebalance job until the first rebalance job meets the at least a portion of the set of checks.

4. The computer-implemented method of claim 1, wherein:
the first transaction is executed by a first smart contract in the first chain network and is recorded in a first blockchain maintained within the first chain network; and
the second transaction is executed by a second smart contract in the second chain network and is recorded in a second blockchain maintained within the second chain network.

5. The computer-implemented method of claim 1, wherein the first transaction changes a first reserve held by a provider of the cryptocurrency within the first chain network by a number of tokens determined based on a difference between a target ratio and an actual ratio, and the second transaction changes a second reserve held by the provider of the cryptocurrency within the second chain network by the number of tokens.

6. The computer-implemented method of claim 1, further comprising:
determining a second set of actual ratios for the set of chain networks;
comparing actual ratios in the second set of actual ratios to respective target ratios in the set of target ratios to provide a second set of differences;
determining that a rebalance job is to be executed for the first chain network in the set of chain networks in response to the second set of differences, and in response, defining a second rebalance job for the first chain network, the second rebalance job comprising a third transaction to be executed on the first chain network and a fourth transaction to be executed on the second chain network; and
executing the second rebalance job in response to determining that the second rebalance job is not a concurrent rebalance job.

7. The computer-implemented method of claim 1, wherein executing the first rebalance job comprises:
transmitting instructions to the first chain network to execute the first transaction; and
transmitting instructions to the second chain network to execute the second transaction.

8. A non-transitory computer-readable storage medium coupled to one or more processors and having instructions stored thereon which, when executed by the one or more processors, cause the one or more processors to perform operations for concurrent rebalancing of tokens of a cryptocurrency across multiple cryptocurrency networks, the operations comprising:
determining a first set of actual ratios for a set of chain networks, each actual ratio in the first set of actual ratios representing a relative number of tokens of a cryptocurrency within a respective chain network of the set of chain networks;
comparing actual ratios in the first set of actual ratios to respective target ratios in a set of target ratios to provide a first set of differences;
determining that a first rebalance job is to be executed for a first chain network in the set of chain networks in response to the first set of differences, and in response, defining a first rebalance job for the first chain network, the first rebalance job comprising a first transaction to be executed on the first chain network and a second transaction to be executed on a second chain network in the set of chain networks;
performing at least a portion of a set of checks based on the first rebalance job and at least one on-going rebalance job in response to determining that the first rebalance job is a concurrent rebalance job; and
executing the first rebalance job in response to the first rebalance job meeting the at least a portion of the set of checks.

9. The non-transitory computer-readable storage medium of claim 8, wherein the at least a portion of the set of checks comprises one or more of:
whether a burn chain of the first rebalance job is a mint chain of the on-going rebalance job;
whether the burn chain of the first rebalance job is a burn chain of the on-going rebalance job;
whether a mint chain of the first rebalance job is a mint chain of the on-going rebalance job and, if so, whether a burn chain of the on-going rebalance job is of slow finality and the mint chain of the on-going rebalance job requires tokens of the cryptocurrency; and
whether one of the mint chain of the first rebalance job is a burn chain of the on-going rebalance job and the mint chain of the on-going rebalance job is blocked by a burn transaction on a burn chain of slow finality.

10. The non-transitory computer-readable storage medium of claim 8, wherein operations further comprise delaying execution of the first rebalance job until the first rebalance job meets the at least a portion of the set of checks.

11. The non-transitory computer-readable storage medium of claim 8, wherein:
the first transaction is executed by a first smart contract in the first chain network and is recorded in a first blockchain maintained within the first chain network; and
the second transaction is executed by a second smart contract in the second chain network and is recorded in a second blockchain maintained within the second chain network.

12. The non-transitory computer-readable storage medium of claim 8, wherein the first transaction changes a first reserve held by a provider of the cryptocurrency within the first chain network by a number of tokens determined based on a difference between a target ratio and an actual ratio, and the second transaction changes a second reserve held by the provider of the cryptocurrency within the second chain network by the number of tokens.

13. The non-transitory computer-readable storage medium of claim 8, wherein operations further comprise:
determining a second set of actual ratios for the set of chain networks;
comparing actual ratios in the second set of actual ratios to respective target ratios in the set of target ratios to provide a second set of differences;
determining that a rebalance job is to be executed for the first chain network in the set of chain networks in response to the second set of differences, and in response, defining a second rebalance job for the first chain network, the second rebalance job comprising a third transaction to be executed on the first chain network and a fourth transaction to be executed on the second chain network; and
executing the second rebalance job in response to determining that the second rebalance job is not a concurrent rebalance job.

14. The non-transitory computer-readable storage medium of claim 8, wherein executing the first rebalance job comprises:
transmitting instructions to the first chain network to execute the first transaction; and
transmitting instructions to the second chain network to execute the second transaction.

15. A system, comprising:
a computing device; and
a computer-readable storage device coupled to the computing device and having instructions stored thereon which, when executed by the computing device, cause the computing device to perform operations for concurrent rebalancing of tokens of a cryptocurrency across multiple cryptocurrency networks, the operations comprising:
determining a first set of actual ratios for a set of chain networks, each actual ratio in the first set of actual ratios representing a relative number of tokens of a cryptocurrency within a respective chain network of the set of chain networks;
comparing actual ratios in the first set of actual ratios to respective target ratios in a set of target ratios to provide a first set of differences;
determining that a first rebalance job is to be executed for a first chain network in the set of chain networks in response to the first set of differences, and in response, defining a first rebalance job for the first chain network, the first rebalance job comprising a first transaction to be executed on the first chain network and a second transaction to be executed on a second chain network in the set of chain networks;
performing at least a portion of a set of checks based on the first rebalance job and at least one on-going rebalance job in response to determining that the first rebalance job is a concurrent rebalance job; and
executing the first rebalance job in response to the first rebalance job meeting the at least a portion of the set of checks.

16. The system of claim 15, wherein the at least a portion of the set of checks comprises one or more of:
whether a burn chain of the first rebalance job is a mint chain of the on-going rebalance job;
whether the burn chain of the first rebalance job is a burn chain of the on-going rebalance job;
whether a mint chain of the first rebalance job is a mint chain of the on-going rebalance job and, if so, whether a burn chain of the on-going rebalance job is of slow finality and the mint chain of the on-going rebalance job requires tokens of the cryptocurrency; and
whether one of the mint chain of the first rebalance job is a burn chain of the on-going rebalance job and the mint chain of the on-going rebalance job is blocked by a burn transaction on a burn chain of slow finality.

17. The system of claim 15, wherein operations further comprise delaying execution of the first rebalance job until the first rebalance job meets the at least a portion of the set of checks.

18. The system of claim 15, wherein:
the first transaction is executed by a first smart contract in the first chain network and is recorded in a first blockchain maintained within the first chain network; and
the second transaction is executed by a second smart contract in the second chain network and is recorded in a second blockchain maintained within the second chain network.

19. The system of claim 15, wherein the first transaction changes a first reserve held by a provider of the cryptocurrency within the first chain network by a number of tokens determined based on a difference between a target ratio and an actual ratio, and the second transaction changes a second reserve held by the provider of the cryptocurrency within the second chain network by the number of tokens.

20. The system of claim 15, wherein operations further comprise:
determining a second set of actual ratios for the set of chain networks;
comparing actual ratios in the second set of actual ratios to respective target ratios in the set of target ratios to provide a second set of differences;
determining that a rebalance job is to be executed for the first chain network in the set of chain networks in response to the second set of differences, and in response, defining a second rebalance job for the first chain network, the second rebalance job comprising a third transaction to be executed on the first chain network and a fourth transaction to be executed on the second chain network; and
executing the second rebalance job in response to determining that the second rebalance job is not a concurrent rebalance job.
